(19) United States
(12) Patent Application Publication
(10) Pub. No.: US 2025/0269388 A1
(43) Pub. Date: Aug. 28, 2025

(54) METHOD AND SYSTEM FOR PURIFICATION OF A CONTAMINATED PRODUCT

(71) Applicant: SKF MFR TECHNOLOGY AB, Stockholm (SE)

(72) Inventor: Lasse HURNASTI, Huddinge (SE)

(21) Appl. No.: 18/857,210

(22) PCT Filed: Apr. 29, 2022
(86) PCT No.: PCT/EP2022/061555

§ 371 Date: Oct. 16, 2024

(51) Int. Cl. B04B 1/08; B04B 7/14; B04B 11/02; B04B 13/00

(52) U.S. Cl. CPC B04B 1/08; B04B 7/14; B04B 11/02; B04B 13/00; B04B 2013/006

(57) ABSTRACT

A purification system (1) includes a disc stack centrifugal separator (3) with a disc stack (31) made of stacked discs (33) having circumferentially spaced-apart distribution holes (39). The distribution holes are configured to distribute a contaminated product over a distribution part (41) of a curved surface area (35) of the disc stack. The distribution part extends around the circumference of the disc stack and over 20%-70% of a total distance (d) between a base periphery (37a) and a top periphery (37b) of the disc stack. At least one pressure control device (11a, 11b) is fluidly connected with at least one of a light phase outlet and a heavy phase outlet and controls a level of backpressure provided to the light phase outlet and/or the heavy phase outlet to adjust a position of an interface between a light phase and a heavy phase in the disc stack during purification.

### TECHNICAL FIELD OF THE INVENTION

The present invention relates to a method and a system for purification of a contaminated product.

### BACKGROUND OF THE INVENTION

Purification of oils, such as for example slop oil, waste oil, slurry oil, crude oil, industrial oil, petroleum products or bio-oils is important for the possibility to use/reuse oils and therefore an important factor for the environmental future and the limited nature resources of oils. Purification of slop oil (and waste oil, hereafter only referred to as slop oil) is problematic in many ways. Slop oil can comprise oil, water, particles and emulsion phase. The particles can stabilize the emulsion phase and complicate a purification process. Purification of industrial emulsions comprising water and oil, such as for example cutting fluids is also an important environmental issue.

In slop oil treatment, centrifuge systems, such as disc stack centrifugal separators, are often used for example for separation of oil and water. Slop oils comprise different ingredients, such as different types of oils, water and particles, in different amounts. Hereby a composition of the slop oil will differ between each batch of slop oil to be purified. It may be hard to achieve a good purification result when different contaminated oils, such as different batches of slop oils are purified in the same system. For example, the amount of water in the contaminated oil to be purified may differ largely between different batches. Furthermore, water which has been separated from the contaminated oil in a disc stack centrifugal separator, often needs to be further purified in a following purification step.

### SUMMARY

An object of the present invention is to provide an improved method and system for purification of a contaminated product comprising light phase and heavy phase.

A further object of the invention is to provide a method and a system by which both the oil part and the water part of a contaminated oil can be efficiently purified.

This is achieved by a method, a system and a computer program product according to the independent claims.

According to one aspect of the invention a purification system for purification of a contaminated product is provided, said purification system comprising:
a disc stack centrifugal separator, wherein said disc stack centrifugal separator comprises:
   an inlet for receiving the contaminated product to be purified in said disc stack centrifugal separator;
   a disc stack comprising a number of stacked discs, wherein each disc has a form of a truncated cone having a curved surface area limited by a base periphery and a top periphery, wherein said curved surface area comprises distribution holes separated around a circumference of the disc, wherein the distribution holes are provided for allowing fluid distribution between the discs in the disc stack, wherein said distribution holes are sized and positioned for distributing the contaminated product to be purified over a distribution part of the curved surface area of the disc, wherein said distribution part is extending around the circumference of the disc and over 20%-70% of a total distance, d, between the base periphery and the top periphery, wherein said distribution part of the curved surface area is provided closer to the base periphery than to the top periphery;
   at least one light phase outlet connected to the disc stack for transferring separated light phase out from the disc stack centrifugal separator; and
   at least one heavy phase outlet connected to the disc stack for transferring separated heavy phase out from the disc stack centrifugal separator;
at least one pressure control device provided in connection with at least one of the light phase outlet of the disc stack centrifugal separator and the heavy phase outlet of the disc stack centrifugal separator, whereby a level of backpressure provided to the light phase outlet and/or the heavy phase outlet can be controlled by controlling the at least one pressure control device, whereby a position of an interface between a light phase and a heavy phase in the disc stack during purification of the contaminated product will be adjusted in response to said controlling of the backpressure.

According to another aspect of the invention a method for purification of a contaminated product in a purification system according to the invention is provided. Said method comprises the steps of:
providing, S1, the contaminated product into the disc stack centrifugal separator;
separating, S2, the contaminated product in the disc stack centrifugal separator into a light phase and a heavy phase;
retrieving, S3, the separated light phase from the light phase outlet of the disc stack centrifugal separator and retrieving the separated heavy phase from the heavy phase outlet of the disc stack centrifugal separator;
determining, S4, a proportion of heavy phase content in the contaminated product which is to be purified;
controlling, S5, a backpressure provided to the heavy phase outlet and/or the light phase outlet of the disc stack centrifugal separator and hereby controlling a position of an interface between heavy phase and light phase during purification of the contaminated product in the disc stack of the disc stack centrifugal separator, said controlling being dependent on the determined proportion of heavy phase content in the contaminated product.

According to another aspect of the invention a computer program product comprising instructions which, when executed in a processor in a control system of the purification system according to the invention, cause the control system to perform the method according to the invention.

Hereby a flexible system is achieved which can be effectively used for purification of different types of contaminated products comprising different proportions of oil and water. Furthermore, thanks to the distribution holes which are sized and positioned for distributing fluid over a comparatively large part of a surface of the discs, a larger part of the disc stack can be used for purification of the heavy phase. In prior art systems purification of heavy phase is not possible or prioritized. Such purification is instead performed in a following purification step. According to the invention both light phase and heavy phase can be efficiently purified in the same disc stack. By controlling the position of the interface between the light phase and the heavy phase in the disc stack in dependence of a determined proportion of heavy phase in the contaminated product to be purified, the interface can be moved closer to a center of the disc stack when a proportion of heavy phase in the contaminated product is increasing. Hereby a larger part of the disc stack can be used for purification of the heavy phase. For efficient purification of both light phase and heavy phase of a contaminated product comprising a significant amount of both heavy phase and light phase, the position of the interface should be controlled to be within the distribution part of the curved surface area. Hereby one part of the disc stack is used for heavy phase purification and one part is used for light phase purification. The interface position is moved closer to the center of rotation of the centrifugal separator when the amount of heavy phase increases whereby a larger part of the disc stack will be used for heavy phase purification. For a contaminated product comprising a very small proportion of heavy phase, i.e. major part is light phase and there is less need for purification of the heavy phase, the interface position can be moved further out from the center, outside the distribution part and possibly even outside an outer edge of the disc stack. Hereby the whole disc stack can be used for light phase purification. For a contaminated product comprising a major part of heavy phase (i.e. only small amounts of light phase), a larger part of the disc stack may be needed for the heavy phase purification and the interface position can be moved further towards the center of rotation of the centrifugal separator. The interface position can even be controlled to be positioned inside the distribution part.

Thanks to the comparatively large size of the distribution part (compared to prior art products having smaller, circular distribution holes) the interface between heavy phase and light phase in the disc stack can be provided further into the disc stack and hereby a larger part of the disc stack can be used for heavy phase purification. The interface can be positioned at different locations inside the distribution part for efficient purification of both light phase and heavy phase. However, the interface can also be positioned outside the distribution part, for example if purification of only one phase is needed.

According to the invention the proportion of heavy phase in the contaminated product to be purified is determined and the control of the position of the interface is provided in dependence of said determined proportion. This can be an automated control system whereby a method and system are achieved by which purification is automatically optimized for different contaminated products to be purified.

Hereby a flexible method and system is achieved in which different types of contaminated products comprising different proportions of heavy phase and light phase can be efficiently purified in the same system. Furthermore, both light phase and heavy phase are purified in the centrifugal separator.

In one embodiment of the invention said distribution part is extending around the circumference of the disc and over 25%-60% of the total distance, d, between the base periphery and the top periphery.

In one embodiment of the invention the purification system comprises further a heavy phase determination arrangement positioned in the purification system and configured for determining a proportion of heavy phase content in the contaminated product which is to be purified in the purification system.

In one embodiment of the invention the purification system further comprises a control system which is provided in communication contact with the heavy phase determination arrangement and with the at least one pressure control device, wherein said control system is configured to control the at least one pressure control device in dependence of the proportion of heavy phase content in the contaminated product determined by the heavy phase determination arrangement.

In one embodiment of the invention said control system is configured to control the at least one pressure control device such that the backpressure provided to the heavy phase outlet and/or light phase outlet is adjusted continuously or repeatedly at predefined intervals.

In one embodiment of the invention the control system is configured to control the backpressure such that a position of an interface between heavy phase and light phase during purification of the contaminated product in the disc stack is moved closer to a center of rotation, c, of the disc stack for increasing proportions of heavy phase content in the contaminated product.

In one embodiment of the invention the heavy phase determination arrangement comprises one or more of: a water in oil sensor provided in connection with the inlet flow sensors provided in connection with one or more of the inlet, the light phase outlet and the heavy phase outlet and a fluid level sensor or load sensor provided in a heavy phase collection tank connected to the heavy phase outlet.

In one embodiment of the invention said distribution holes are elongated holes extending in a direction from the base periphery to the top periphery.

In one embodiment of the invention said distribution holes have a length, l, being between 20%-70% or between 25%-50% of the distance, d, between the base periphery and the top periphery and wherein said distribution holes are positioned closer to the base periphery than to the top periphery.

In one embodiment of the invention the purification system further comprises at least one pressure sensor which is provided in fluid connection with at least one of the light phase outlet or the heavy phase outlet, wherein said at least one pressure sensor is provided in communication contact with said control system and whereby said control system is configured to control said at least one pressure control device further in dependence on a reading from said at least one pressure sensor.

In one embodiment of the invention the purification system further comprises a contaminated product tank comprising contaminated product to be purified, wherein said contaminated product tank comprises an outlet which is fluidly connected to the inlet of the disc stack centrifugal separator possibly via one or more further oil treatment units.

In one embodiment of the invention said at least one pressure control device is at least one control valve provided to a light phase fluid line connected to the light phase outlet and/or to a heavy phase fluid line connected to the heavy phase outlet.

In one embodiment of the invention said step of controlling, S5, comprises controlling the backpressure provided to the heavy phase outlet and/or the light phase outlet in dependence of the determined proportion of heavy phase content in the contaminated product such that the disc stack can be used for purification of both the light phase and the heavy phase, whereby the method is a method for purification of a contaminated product wherein both the light phase and the heavy phase can be purified in the disc stack of the disc stack centrifugal separator.

In one embodiment of the invention the step of controlling, S5, a backpressure comprises controlling the backpressure such that the position of the interface between heavy phase and light phase in the disc stack is moved closer to a center of rotation, c, of the disc stack for increasing proportions of heavy phase content in the contaminated product.

In one embodiment of the invention said steps of determining, S4, a proportion of heavy phase content and controlling, S5, a backpressure are performed continuously or repeatedly at predefined intervals during purification of contaminated product.

In one embodiment of the invention the step of determining, S4, a proportion of heavy phase content comprises one or more of: determining a proportion of heavy phase in the contaminated product using a water in oil sensor provided in connection with the inlet, measuring and comparing flows by use of flow sensors provided in connection with one or more of the inlet, the light phase outlet and the heavy phase outlet and measuring a fluid level or a load by a fluid level sensor or load sensor provided in a heavy phase collection tank connected to the heavy phase outlet.

In one embodiment of the invention said step of controlling, S5, a backpressure comprises controlling the pressure control device provided in connection with the heavy phase outlet and/or the pressure control device provided in connection with the light phase outlet of the disc stack centrifugal separator.

### BRIEF DESCRIPTION OF THE DRAWINGS

FIG. 1 shows schematically an oil purification system according to one embodiment of the invention.

FIG. 2A shows schematically a cross section of a part of a disc stack centrifugal separator with a disc stack comprising discs having a comparatively small distribution part which may be used in prior art systems and FIG. 2B shows a perspective view of some of the discs in the disc stack having circular and comparatively small distribution holes.

FIG. 3A shows schematically a cross section of a part of a disc stack centrifugal separator according to one embodiment of the invention and FIG. 3B shows a perspective view of some of the discs in the disc stack.

FIG. 4A shows schematically a cross section of a part of a disc stack centrifugal separator and FIG. 4b shows a perspective view of some of the discs in the disc stack according to the same embodiment of the invention as shown in FIGS. 3A and 3B but with a different position of an interface between heavy phase and light phase illustrated.

FIG. 5A shows schematically a cross section of a part of a disc stack centrifugal separator and FIG. 5B shows a perspective view of some of the discs in the disc stack according to the same embodiment of the invention as shown in FIGS. 3A and 3B but with a different position of an interface between heavy phase and light phase illustrated.

FIG. 6 is a flow chart of a method according to one embodiment of the invention.

### DETAILED DESCRIPTION OF THE EMBODIMENTS

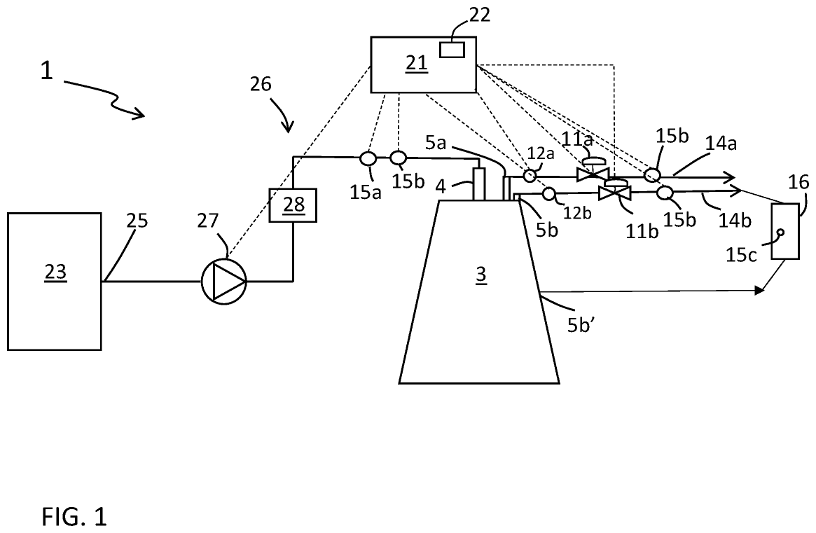

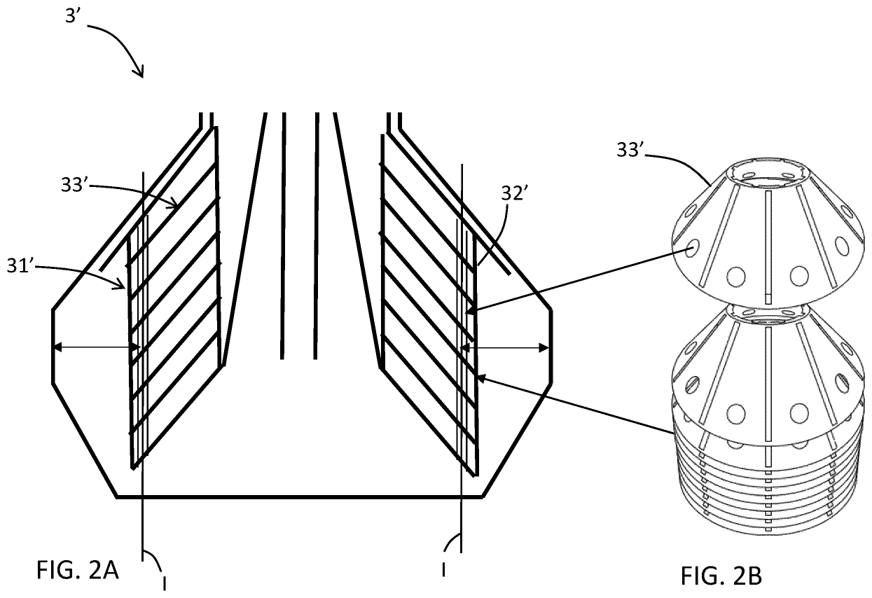

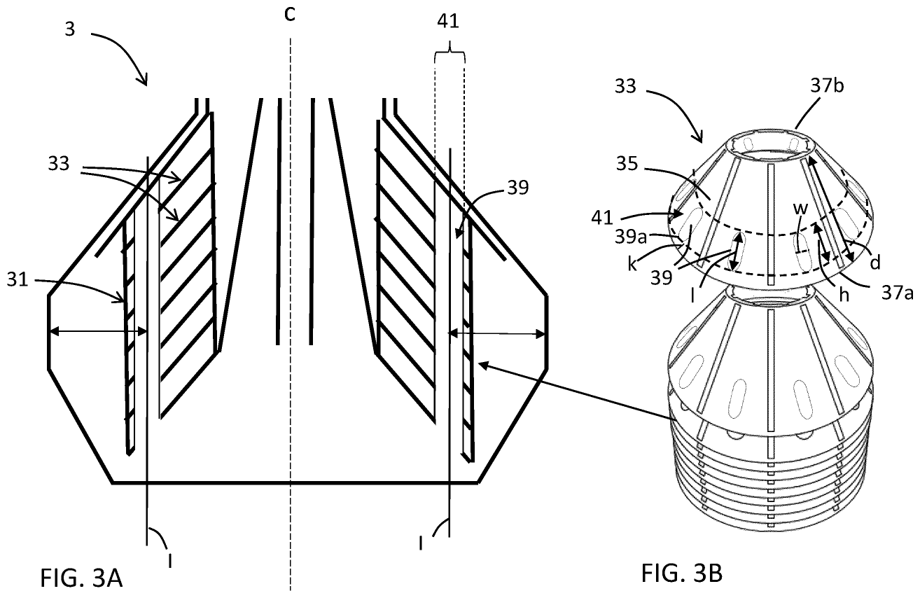

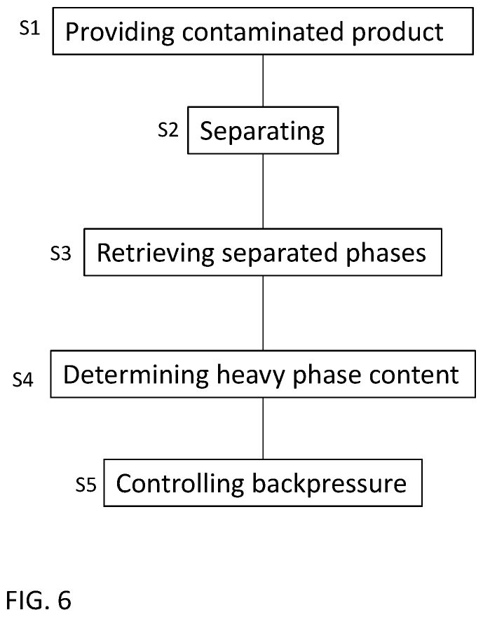

FIG. 1 shows schematically a purification system 1 according to one embodiment of the invention. FIG. 6 is a flow chart of a method according to one embodiment of the invention. FIGS. 3-5 illustrate the principle according to the invention in a schematic representation of some parts of a disc stack centrifugal separator 3. FIG. 2 is provided as a schematic reference to a centrifuge which may be used in prior art systems. The dimensions, positions and number of distribution holes in the discs are however only schematically illustrated and are not a real illustration of an actual prior art product. FIGS. 2A and 2B are only provided for giving a schematic illustrative comparison between different types of distribution holes.

The purification system 1 comprises a disc stack centrifugal separator 3. The disc stack centrifugal separator 3 is schematically shown in FIG. 1 to comprise an inlet 4 through which a contaminated product to be purified can be provided into the disc stack centrifugal separator 3. The contaminated product can comprise heavy phase and light phase (also referred to as water and oil) in different proportions. In FIG. 1 a contaminated product tank 23 is also schematically shown comprising an outlet 25 which is fluidly connected by at least one fluid connection 26 to the inlet 4 of the disc stack centrifugal separator 3. A pump 27 is also shown connected in the at least one fluid connection 26 for pumping the contaminated product from the contaminated product tank 23 to the inlet 4 of the disc stack centrifugal separator 3. In some embodiments of the invention other treatment units 28 can be provided in the at least one fluid connection 26 between the contaminated product tank 23 and the disc stack centrifugal separator 3. These other treatment units 28 are only schematically shown as one unit. The other treatment units 28 can for example comprise one or more filters, one or more mixing units, a separation aid adding device, one or more buffer tank, one or more settling tanks or one or more further centrifugal separators.

The disc stack centrifugal separator 3 comprises furthermore at least one light phase outlet 5a and at least one heavy phase outlet 5b, 5b′. The contaminated product is separated in the disc stack centrifugal separator 3 into a light phase and a heavy phase whereby a light phase will be retrieved from the disc stack centrifugal separator 3 from the light phase outlet 5a and a heavy phase will be retrieved from the disc stack centrifugal separator from the heavy phase outlet 5b, 5b′ after the separation.

FIGS. 3A, 4A and 5A show schematically cross sections of parts of a disc stack centrifugal separator 3. These are only schematic principal views for a disc stack centrifugal separator 3 which can be used for the invention. There are different types of disc stack centrifugal separators 3 which can be used. Some examples are continuously discharging centrifuges, such as nozzle centrifuges (separator) and other examples are intermittent discharging centrifuges. According to the invention a backpressure provided to the heavy phase outlet 5b and/or the light phase outlet 5a of the disc stack centrifugal separator 3 is controlled whereby a position of an interface, I, between heavy phase and light phase during purification of the contaminated product in a disc stack 31 of the disc stack centrifugal separator 3 also is controlled. In a continuously discharging centrifuge, such as a nozzle centrifuge, a position of the interface, I, between heavy phase and light phase in the disc stack 31 can be directly controlled by controlling the backpressure provided to one of the heavy phase or light phase outlet 5a, 5b. However, for an intermittent discharging centrifuge a position of an interface, I, between the light phase and the heavy phase in the disc stack is usually fixedly set by the positioning of a gravity disc to a heavy phase outlet chamber (also called water paring chamber) and a level ring to a light phase outlet chamber (also called oil paring chamber) of the disc stack centrifugal separator. If the position of the interface between heavy phase and light phase in the disc stack needs to be adjusted the gravity disc and/or level ring can be changed to another one having another inner diameter whereby the position of the interface between heavy phase and light phase in the disc stack will be moved. If an intermittent discharging type centrifuge is to be used for this invention the centrifuge needs to be provided with a heavy phase outlet chamber and/or a light phase outlet chamber in which a fluid level can be controlled. This can be achieved for example by removing a gravity disc or by providing a gravity disc with a comparatively large inner diameter. Hereby the heavy and/or light phase outlet chamber of the disc stack centrifugal separator will allow for a fluid level to be controlled to different positions. By controlling the fluid level in the heavy and/or light phase outlet chamber the position of the interface between heavy phase and light phase in the disc stack 31 will also be moved. The fluid level in the heavy and/or light phase outlet chamber can be moved by controlling a back pressure provided to the heavy and/or light phase outlet 5a, 5b of the centrifugal separator 3.

An inlet 4, a light phase outlet 5a and a heavy phase outlet 5b of the disc stack centrifugal separator 3 are schematically shown in FIG. 1. Furthermore, a second heavy phase outlet 5b′ of the disc stack centrifugal separator 3 is schematically shown in FIG. 1. A second heavy phase outlet 5b′ is only provided in some types of disc stack centrifugal separators, such as in continuously discharging disc stack centrifugal separators. In FIGS. 3-5 parts of a disc stack centrifugal separator 3 which can be used in the purification system 1 according to the invention is schematically shown. In FIGS. 3A, 4A and 5A a disc stack 31 of the disc stack centrifugal separator 3 is schematically shown in cross section and in FIGS. 3B, 4B and 5B some of the discs 33 are shown separate in a perspective view. The heavy and light phases are separated in this disc stack 31 according to what is well known for disc stack centrifugal separators.

In FIGS. 2A and 2B a disc stack centrifugal separator 3′ is schematically shown. As discussed above this is not an illustration of a real prior art product but just given as a schematic comparison in relation to the invention which is illustrated in FIGS. 3-5. A disc stack 31′ comprising a number of discs 33′ is shown in cross section in FIG. 2A. Some of the discs 33′ are separately shown in perspective in FIG. 2B. The discs 33′ comprise distribution holes 39′ provided for allowing fluid distribution between the discs 33′ in the disc stack 31′. An interface, I, between a heavy phase and a light phase is illustrated to be positioned in the middle of the distribution holes 39′. In prior art systems the interface between the heavy phase and the light phase in the disc stack 31′ should suitably be positioned somewhere between a position just outside a disc stack outer edge 32′ and a middle of the distribution holes 39′. With such a location of the interface position the flow will be distributed evenly giving same flow rate between every disc 33′ in the disc stack 31′. If the interface position, I, is going too far outside the disc stack edge 32′, oil will be lost into the water outlet. The so-called “water lock” is lost and oil is going out the wrong way unseparated. If the interface position, I, is located from the middle of the distribution holes 39′ and inwards this will be acting as a flow restriction since most of the distribution holes 39′ will have a water density level where the incoming oil feed is provided. This density difference creates an uneven distribution in the disc stack 31′ and consequently poor separability. The position of the interface, I, is hereby rather limited for a such a system having comparatively small distribution holes 39′.

In FIGS. 3A, 4A and 5A parts of a disc stack centrifugal separator 3 which can be used in the purification system 1 according to the invention is schematically shown in cross section. An interface, I, between heavy phase and light phase is illustrated at different positions within the disc stack 31 in FIGS. 3A, 4A and 5A. The disc stack centrifugal separator 3 comprises a disc stack 31 which is shown in cross section. The disc stack 31 comprises a number of stacked discs 33. Each disc 33 in the disc stack 31 has a form of a truncated cone having a curved surface area 35 limited by a base periphery 37a and a top periphery 37b. In FIGS. 3-5 it is shown that all discs 33 are identical. Other discs having differing features and sizes may however also be provided in the disc stack centrifugal separator according to the invention. There may be additional discs provided in connection with the disc stack 31 which may have another design. For example, there are examples of disc stacks where one end of the disc stack comprises discs of a smaller size. Such examples of disc stacks should also be covered by this invention.

The curved surface area 35 of each disc 33 comprises distribution holes 39 separated around a circumference of the disc 33. The distribution holes 39 are provided for allowing fluid distribution between the discs 33 in the disc stack 31. The distribution holes 39 are sized and positioned for distributing the contaminated product to be purified in the disc stack centrifugal separator 3 over a distribution part 41 of the curved surface area 35 of the disc 33. The distribution part 41 is extending around the circumference of the disc 33 and over 20%-70% of a total distance, d, between the base periphery 37a and the top periphery 37b. In one embodiment of the invention the distribution part 41 is extending around the circumference of the disc 33 and over 25%-60% of the total distance, d, between the base periphery 37a and the top periphery 37b. Hereby the distribution part 41 is defined as a band around the disc 33 having a height, h, being between 20%-70% or between 25%-60% of the distance, d, between the base periphery 37a and the top periphery 37b. Said distribution part 41 of the curved surface area 35 is provided closer to the base periphery 37a than to the top periphery 37b. A first end 39a of each distribution hole 39, which first end 39a is the end of the distribution hole 39 which is provided closest to the base periphery 37a, can in some embodiments of the invention be positioned at a distance, k, from the base periphery 37a which can be from 0-40% of the total distance, d, between the base periphery 37a and the top periphery 37b.

According to one embodiment of the invention, as shown in FIGS. 3-5 the distribution holes 39 are extended along a direction between the base periphery 37a and the top periphery 37b within the distribution part 41 of the curved surface area 35. However, other alternatives are possible, where for example a number of separate distribution holes are provided along a direction between the base periphery 37a and the top periphery 37b_within the distribution part 41 of the curved surface area 35. In some embodiments said distribution holes 39 are elongated holes extending in a direction from the base periphery 37a to the top periphery 37b. Said distribution holes 39 may have a length, 1, being between 20%-70% or between 25%-50% of a distance, d, between the base periphery 37a and the top periphery 37b. Said distribution holes 39 are positioned closer to the base periphery 37a than to the top periphery 37b. A width, w, of the distribution holes 39 will depend on the size of the centrifugal separator. The width, w, can in some embodiments be between 5-60 mm. The number of distribution holes 39 around the circumference of the disc 33 corresponds in some embodiments of the invention to the number of distribution channels/tubes which are supplying incoming feed to the disc stack 31. Hereby, in some embodiments of the invention there is one distribution hole 39 provided to each distribution channel. The number of distribution channels is dependent on type and size of centrifugal separator.

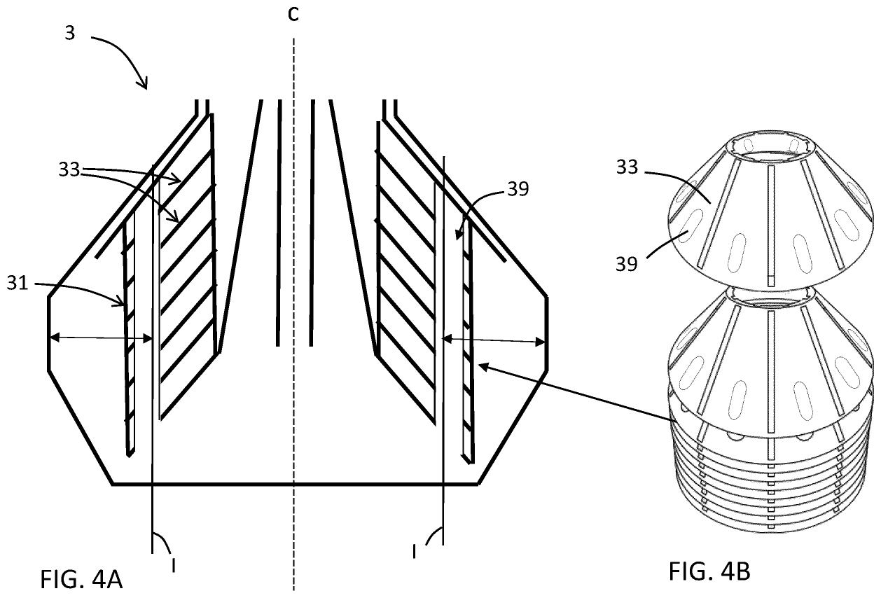

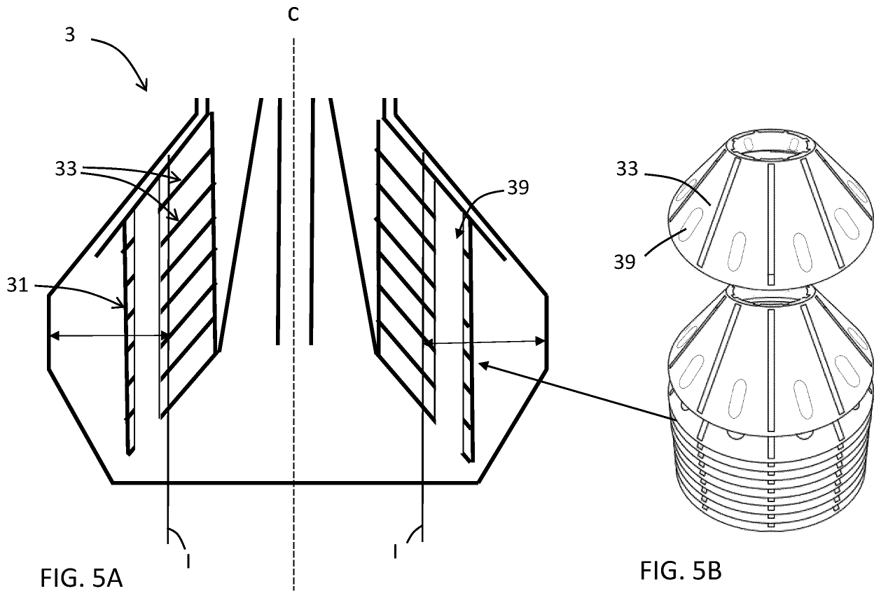

Hereby, according to the invention a larger part of a surface area of the disc 33 can be used for fluid distribution compared to in prior art systems where smaller distribution holes are used as for example schematically illustrated in FIGS. 2A and 2B. Hereby distribution of fluid is allowed over a larger part of the discs 33 in the disc stack 31. This is illustrated in FIGS. 3A, 4A and 5A. The distribution holes 39 are aligned and can be seen in cross section as an opening through the disc stack 31. Thanks to the larger distribution holes 39 and larger distribution part 41 according to the invention in comparison with prior art, a position of an interface, I, between heavy phase and light phase within the disc stack 31 during separation can be varied more compared to what is possible in prior art disc stacks (as illustrated in FIGS. 2A and 2B). Hereby a larger part of the disc stack 31 can be used for purification of the heavy phase. According to the invention a position of the interface, I, between heavy phase and light phase in the disc stack 31 is controlled in dependence of the proportion of heavy phase content in the contaminated product to be purified. For larger proportions of heavy phase in the contaminated product the position of the interface, I, can be controlled to move closer to a center of rotation, c, of the disc stack and hereby a larger part of the disc stack 31 will be used for purification of the heavy phase. If both heavy phase and light phase is to be purified in the disc stack the position of the interface, I, should suitably be kept inside the area of the distribution holes 39, i.e. inside the distribution part 41, as shown in FIGS. 3A and 4A. in FIG. 4A the interface, I, has been moved closer to the center of rotation, c, of the disc stack 31 compared to in FIG. 3A. This is suitable when the proportion of heavy phase in the contaminated product has been increased. For contaminated products comprising even more heavy phase the position of the interface, I, can be moved further into the disc stack 31 in order to use an even larger part of the disc stack 31 for heavy phase purification. This is illustrated in FIG. 5A. Hereby, thanks to the invention both light phase and heavy phase can be efficiently purified within the same disc stack centrifugal separator 3. The proportion of heavy phase is determined, and a backpressure provided to one of the light phase or heavy phase outlets, 5a, 5b of the disc stack centrifugal separator 3 is controlled in dependence of said determined proportion of heavy phase in order for adjusting the position of the interface, I, between heavy phase and light phase in the disc stack 31.

At least one pressure control device 11a, 11b is provided in fluid connection with at least one of a light phase outlet 5a of the disc stack centrifugal separator 3 and a heavy phase outlet 5b of the disc stack centrifugal separator 3. The pressure control device 11a, 11b can be for example a control valve 11a, 11b provided to a light phase fluid line 14a connected to the light phase outlet 5a and/or to a heavy phase fluid line 14b connected to the heavy phase outlet 5b. Hereby a level of backpressure provided to the light phase outlet 5a and/or the heavy phase outlet 5b can be controlled by controlling the at least one pressure control device 11a, 11b. Either the backpressure for only one of the heavy phase or light phase outlets 5a, 5b is controlled according to the invention and hereby provided with a pressure control device 11a, 11b or both of the heavy and light phase outlets 5a, 5b can be controlled. According to the invention a level of backpressure provided to the light phase outlet 5a and/or the heavy phase outlet 5b can be controlled by controlling the at least one pressure control device 11a, 11b, whereby a position of an interface between a light phase and a heavy phase in the disc stack 31 during purification of the contaminated product will be adjusted in response to said controlling of the backpressure.

In order to control a position of the interface in the disc stack 31 only one of the heavy phase outlet 5b or the light phase outlet 5a has to be controlled by providing a controlled back pressure according to the invention. In FIG. 1 it is however shown to be control valves 11a, 11b provided in connection with both the light phase outlet 5a and the heavy phase outlet 5b. Backpressure control of only one of the outlets 5a, 5b is enough and the other components may therefore be omitted.

According to one embodiment of the invention the purification system 1 comprises further a heavy phase determination arrangement 15a, b, c which is configured for determining a proportion of heavy phase content in the contaminated product which is to be purified in the purification system. The heavy phase determination arrangement 15a, b, c may comprise one or more sensors 15a, b, c which are configured for measuring one or more features which can be used for determining the proportion of heavy phase content in the contaminated product. More specifically the heavy phase determination arrangement may comprise one or more of: a water in oil sensor 15a (heavy phase content in light phase sensor) provided in connection with the inlet 4, flow sensors 15b provided in connection with one or more of the inlet 4, the light phase outlet 5a and the one or more heavy phase outlet 5b, 5b′ and a fluid level sensor or a load sensor 15c provided in a heavy phase collection tank 16 connected to the heavy phase outlet 5b, 5b′. An amount of heavy phase retrieved from the disc stack centrifugal separator 3 can be measured for example by a flow sensor 15b provided in connection with the at least one heavy phase outlet 5b, 5b′ or by a fluid level sensor or a load sensor 15c provided in the heavy phase collection tank 16. If heavy phase is transported out from the heavy phase collection tank 16 at a known flow rate, changes measured by the fluid level sensor 15c or load sensor 15c can be registered for determining the proportion of heavy phase in the contaminated product to be purified.

By comparing this amount of heavy phase with an amount of contaminated product provided into the disc stack centrifugal separator 3 during the same time period a proportion of heavy phase in the contaminated product can be determined. Alternatively, the corresponding amount of light phase can be determined by measuring light phase flow rate in the light phase outlet or amount of light phase in a light phase collection tank and compare this with the incoming flow rate of contaminated product. Another alternative is to detect the proportion of heavy phase in light phase by a water in oil sensor 15a (heavy phase content in light phase sensor) connected in contact with the inlet 4. Hereby a heavy phase determination arrangement 15a,b,c can be designed in different ways and may comprise different types of sensors. Examples of water in oil sensors can be capacitive RH (relative humidity) sensor/ADC−Advance Digital Capacitance/LC-Oscillator+Resistance.

The oil purification system 1 comprises furthermore a control system 21 which is provided in communication contact with the heavy phase determination arrangement 15a,b,c. The control system 21 is further provided in communication contact with the at least one pressure control device 11a, 11b, wherein said pressure control device 11a, 11b can be controlled in dependence of the determined proportion of heavy phase in the contaminated product to be purified. The control device 21 is in communication connection with the heavy phase determination arrangement 15a,b,c and with the at least one pressure control device 11a, 11b, i.e. a wireless or wired connection. The connections with the control system 21 are shown by dotted lines in FIG. 1. Suitably at least one pressure sensor 12a, 12b is provided in fluid connection with at least one of the light phase outlet 5a or the heavy phase outlet 5b. In FIG. 1 a light phase pressure sensor 12a is provided in connection with the light phase outlet 5a. The light phase pressure sensor 12a is here provided in the light phase fluid line 14a connected to the light phase fluid outlet 5a. Correspondingly a heavy phase pressure sensor 12b may be provided in connection with the heavy phase outlet 5b, for example provided in the heavy phase fluid line 14b which is connected to the heavy phase outlet 5b. However, only one of these two pressure sensors 14a, 14b would be needed for controlling a back pressure to only one of the heavy and light phase outlets 5a, 5b. The light phase pressure sensor 12a and/or the heavy phase pressure sensor 12b are also provided in connection with the control system 21 and hereby the control system 21 can control the at least one pressure control device 11a, 11b according to readings from this at least one pressure sensor 12a, 12b.

Said control system 21 may be configured to control the at least one pressure control device 11a, 11b such that the backpressure provided to the heavy phase outlet 5b and/or light phase outlet 5a is adjusted continuously or repeatedly at predefined intervals. Hereby the centrifugal separator 3 can be adopted for different conditions continuously or at repeated intervals. For example if the proportions between heavy phase and light phase in the contaminated product is changed due to for example different batches of contaminated products this change will be measured by the heavy phase determination arrangement 15a,b,c and the backpressure provided to the heavy phase outlet 5b or the light phase outlet 5a can be controlled by a suitable and corresponding amount such that the position of the interface, I, between heavy phase and light phase in the disc stack 31 is moved a suitable distance. The control system 21 is in some embodiments configured to control the backpressure such that a position of an interface, I, between heavy phase and light phase during purification of the contaminated product in the disc stack 31 is moved closer to a center of rotation, c, of the disc stack 31 for increasing proportions of heavy phase content in the contaminated product. The correlation between change in backpressure and movement of position of the interface in the disc stack needs to be calculated since it is depending on density differences heavy phase/light phase, viscosity, flow rate and heavy phase content.

The light phase separated in the disc stack centrifugal separator 3 in the oil purification system 1 according to the invention can be oil of different types. The heavy phase can for example be water, water comprising salt, such as brine or water with added mono ethylene glycol (MEG).

In FIG. 6 a flow chart of a method for purification of contaminated product according to one embodiment of the invention is shown. The method steps are described below:
S1: Providing contaminated product into a disc stack centrifugal separator 3 of a purification system 1 as described above in relation to FIGS. 1, 3, 4 and 5.
S2: Separating the contaminated product in the disc stack centrifugal separator 3 into a light phase and a heavy phase.
S3: Retrieving the separated light phase from a light phase outlet 5a of the disc stack centrifugal separator 3 and retrieving the separated heavy phase from a heavy phase outlet 5b of the disc stack centrifugal separator 3.
S4: Determining a proportion of heavy phase content in the contaminated product to be purified. This can be determined in different ways by the heavy phase determination arrangement 15a,b,c as described above.
S5: Controlling a backpressure provided to the heavy phase outlet 5b and/or the light phase outlet 5a of the disc stack centrifugal separator 3 and hereby controlling a position of the interface, I, between the heavy phase and the light phase during purification of the contaminated product in the disc stack 31 of the disc stack centrifugal separator 3, said controlling being dependent on the determined proportion of heavy phase content in the contaminated product to be purified.

The step of controlling a backpressure, S5, may comprise controlling the backpressure provided to the heavy phase outlet 5b, and/or the light phase outlet 5a in dependence of the determined proportion of heavy phase content in the contaminated product such that the disc stack 31 can be used for purification of both the light phase and the heavy phase. Hereby the method is a method for purification of a contaminated product wherein both the light phase and the heavy phase can be purified in the disc stack 31 of the disc stack centrifugal separator 3.

The step of controlling a backpressure, S5, comprises controlling the backpressure such that the position of the interface between heavy phase and light phase in the disc stack 31 is moved closer to a center of rotation, c, of the disc stack 31 for increasing proportions of heavy phase content in the contaminated product.

Said steps of determining a proportion, S4, and controlling a backpressure, S5, may be performed continuously or repeatedly at predefined intervals during purification of the contaminated product.

In some embodiments of the invention the step of controlling a backpressure, S5, comprises controlling a control valve 11b provided to the heavy phase outlet 5b, and/or a control valve 11a provided to the light phase outlet 5a of the disc stack centrifugal separator 3.

A computer program product is also provided. Said computer program product comprises instructions which, when executed in a processor 22 in the control system 21 of the purification system 1 according to the invention, cause the control system 21 to perform the method as described above in relation to FIG. 6.

1. A purification system for purification of a contaminated product, comprising:
a disc stack centrifugal separator comprising:
an inlet configured to receive the contaminated product to be purified in said disc stack centrifugal separator;
a disc stack comprising a number of stacked discs, wherein each disc is formed as a truncated cone having a curved surface area bounded by a base periphery and a top periphery, said curved surface area comprises distribution holes spaced apart around a circumference of the disc, the distribution holes enable fluid distribution between the discs in the disc stack, said distribution holes are sized and positioned to distribute the contaminated product to be purified over a distribution part of the curved surface area of the disc, said distribution part is extends around the circumference of the disc and over 20%-70% of a total distance (d) between the base periphery and the top periphery, and said distribution part of the curved surface area is provided disposed closer to the base periphery than to the top periphery;
at least one light phase outlet fluidly connected to the disc stack and configured to convey separated light phase out from the disc stack centrifugal separator; and
at least one heavy phase outlet fluidly connected to the disc stack and configured to convey separated heavy phase out from the disc stack centrifugal separator; and
at least one pressure control device fluidly connected with at least one of the light phase outlet and the heavy phase outlet, wherein the at least one pressure control device is configured to control a level of backpressure provided to the light phase outlet and/or the heavy phase outlet such that a position of an interface between a light phase and a heavy phase in the disc stack during purification of the contaminated product is adjustable in response to said controlling of the backpressure.

2. The purification system according to claim 1, wherein said distribution part extends over 25%-60% of the total distance (d).

3. The purification system according to claim 1, further comprising a heavy phase determination arrangement operably coupled to the purification system and configured to determine a proportion of heavy phase content in the contaminated product which is to be purified in the purification system.

4. The purification system according to claim 3, further comprising a control system in electrical communication with the heavy phase determination arrangement and with the at least one pressure control device, wherein said control system is configured to control the at least one pressure control device in dependence on the proportion of heavy phase content in the contaminated product in response to a determination of the heavy phase content by the heavy phase determination arrangement.

5. The purification system according to claim 4, wherein said control system is configured to control the at least one pressure control device such that the backpressure provided to the heavy phase outlet and/or light phase outlet is adjusted either continuously or repeatedly at predefined intervals.

6. The purification system according to claim 4, wherein the control system is configured to control the backpressure such that the position of the interface between the heavy phase and the light phase during purification of the contaminated product in the disc stack is moved closer to a center of rotation (c) of the disc stack to increase proportions of heavy phase content in the contaminated product.

7. The purification system according to claim 3, wherein the heavy phase determination arrangement comprises one or more of:
a water in oil sensor in fluid communication with the inlet,
flow sensors in fluid communication with one or more of the inlet, the light phase outlet and the heavy phase outlet, and
a fluid level sensor or load sensor provided in a heavy phase collection tank that is fluidly connected to the heavy phase outlet.

8. The purification system according to claim 1, wherein said distribution holes are elongated holes having a longest extension extending in a direction from the base periphery to the top periphery.

9. The purification system according to claim 8, wherein:
said distribution holes have a length (l) of between 25%-50% of the distance (d), and
said distribution holes are positioned closer to the base periphery than to the top periphery.

10. The purification system according to claim 1, further comprising:
at least one pressure sensor fluidly connected with at least one of the light phase outlet or the heavy phase outlet,
wherein:
said at least one pressure sensor is in electrical communication with said control system, and
said control system is configured to control said at least one pressure control device further in dependence on a reading from said at least one pressure sensor.

11. The purification system according to claim 1, further comprising:
a contaminated product tank containing contaminated product to be purified, and comprising an outlet fluidly connected to the inlet of the disc stack centrifugal separator.

12. The purification system according to claim 1, wherein said at least one pressure control device comprises at least one control valve provided to in a light phase fluid line fluidly connected to the light phase outlet and/or in a heavy phase fluid line fluidly connected to the heavy phase outlet.

13. A method for purification of a contaminated product in the purification system according to claim 1, said method comprising:
providing the contaminated product into the disc stack centrifugal separator;
separating the contaminated product in the disc stack centrifugal separator into a light phase and a heavy phase;
retrieving the separated light phase from the light phase outlet of the disc stack centrifugal separator and retrieving the separated heavy phase from the heavy phase outlet of the disc stack centrifugal separator;
determining a proportion of heavy phase content in the contaminated product to be purified;
controlling a backpressure provided to the heavy phase outlet and/or the light phase outlet and thereby controlling the position of the interface between the heavy phase and the light phase during purification of the contaminated product in the disc stack, said controlling being dependent on the determined proportion of heavy phase content in the contaminated product to be purified.

14. The method according to claim 13, wherein:
said controlling step comprises controlling the backpressure provided to the heavy phase outlet and/or the light phase outlet in dependence on the determined proportion of heavy phase content in the contaminated product such that the disc stack purifies both the light phase and the heavy phase, and
the method is a method for purification of a contaminated product in which both the light phase and the heavy phase are purified in the disc stack.

15. The method according to claim 13, wherein said controlling step comprises controlling the backpressure such that the position of the interface between the heavy phase and the light phase in the disc stack is moved closer to a center of rotation (c) of the disc stack to increase proportions of heavy phase content in the contaminated product.

16. The method according to claim 13, wherein said determining step and said controlling step are performed continuously or repeatedly at predefined intervals during purification of the contaminated product.

17. The method according to claim 13, wherein said determining step comprises one or more of:
determining a proportion of the heavy phase in the contaminated product using a water in oil sensor fluidly connected with the inlet,
measuring and comparing flows using flow sensors fluidly connected with one or more of the inlet, the light phase outlet and the heavy phase outlet, and
measuring a fluid level or a load by a fluid level sensor or load sensor provided in a heavy phase collection tank that is fluidly connected to the heavy phase outlet.

18. The method according to claim 13, wherein said controlling step comprises controlling the pressure control device fluidly connected with the heavy phase outlet and/or the pressure control device fluidly connected with the light phase outlet of the disc stack centrifugal separator.

19. A non-transient computer-readable medium having instructions stored thereon which, when executed in a processor in a control system of a purification system, cause the control system to perform the method according to claim 13.

20. The purification system according to claim 5, wherein:
the control system is configured to control the backpressure such that the position of the interface between the heavy phase and the light phase during purification of the contaminated product in the disc stack is moved closer to a center of rotation (c) of the disc stack to increase proportions of heavy phase content in the contaminated product;
the heavy phase determination arrangement comprises one or more of:
a water in oil sensor in fluid communication with the inlet,
flow sensors in fluid communication with one or more of the inlet, the light phase outlet and the heavy phase outlet, and
a fluid level sensor or load sensor provided in a heavy phase collection tank that is fluidly connected to the heavy phase outlet;
said distribution holes are elongated holes having a longest extension extending in a direction extending from the base periphery to the top periphery;
said distribution holes have a length (l) of between 25%-50% of the distance (d), and are positioned closer to the base periphery than to the top periphery; and
the purification system further comprises at least one pressure sensor fluidly connected with at least one of the light phase outlet or the heavy phase outlet and in electrical communication with said control system, said control system being further configured to control said at least one pressure control device in dependence on a reading from said at least one pressure sensor.
